(19) United States
(12) Patent Application Publication
(10) Pub. No.: US 2012/0228440 A1
(43) Pub. Date: Sep. 13, 2012

(54) ADJUSTABLE SUPPORT APPARATUS

(76) Inventors: David A. Jahnke, Suring, WI (US); Timothy J. Pautsch, Appleton, WI (US)

(21) Appl. No.: 13/416,238

(22) Filed: Mar. 9, 2012

Related U.S. Application Data
(60) Provisional application No. 61/450,869, filed on Mar. 9, 2011.

(51) Int. Cl. F16M 11/08

(52) U.S. Cl. 248/125.1

(57) ABSTRACT

Support apparatuses and methods of operating support apparatuses are provided. In one example, a support apparatus includes a support member including a longitudinal central axis extending in a z-direction of a three-dimensional coordinate system including an x-direction, y-direction, and the z-direction, a body coupled to and movable along the support member, and an arm coupled to the body and rotatable relative to the body about a first vertical axis, with the first vertical axis offset from the longitudinal central axis in both the x-direction and the y-direction. In another example, a method of operating a support apparatus includes positioning the support apparatus in a storage position, in which a platform of the support apparatus is at least partially positioned underneath a horizontal surface of a table, and moving the support apparatus from the storage position to an operating position, in which the platform is out from underneath the horizontal surface.

### RELATED APPLICATIONS

The present application claims the benefit of co-pending U.S. Provisional Patent Application Nos. 61/450,869, filed Mar. 9, 2011, the contents of which is hereby incorporated herein by reference.

### FIELD OF THE INVENTION

The present invention generally relates to support apparatuses and methods of operating support apparatuses and, more particularly, to adjustable support apparatuses connectable to a leg of a table and methods of operating adjustable support apparatuses.

### SUMMARY

In one example, a support apparatus is provided.

In another example, an adjustable support apparatus is provided.

In yet another example, a method of operating a support apparatus is provided.

In still another example, a method of operating an adjustable support apparatus is provided.

In a further example, a method of adjusting a support apparatus is provided.

In yet a further example, a support apparatus is provided and the support apparatus may have its height adjusted, may be adjusted between a plurality of operating positions, and may be adjusted between one or more operating positions and a storage position.

In still a further example, a support apparatus is provided and includes a base, an arm rotatably coupled to the base, and a support platform rotatably coupled to the arm. In some aspects, the arm may rotate about a vertical axis relative to the base and the support platform may rotate about a horizontal axis relative to the arm. In other aspects, the support platform may rotate about both a horizontal axis and a vertical axis relative to the arm.

In another example, a support apparatus is provided and is adjustable between a plurality of positions. In some aspects, the support apparatus includes a locking assembly for locking the support apparatus in the plurality of positions.

In yet another example, a support apparatus is provided and includes a support member including a longitudinal central axis extending in a z-direction of a three-dimensional coordinate system including an x-direction, a y-direction, and the z-direction, a body coupled to and movable along the support member, an arm coupled to the body and rotatable relative to the body about a first vertical axis, wherein the first vertical axis is offset from the longitudinal central axis of the support member in both the x-direction and the y-direction, and a platform coupled to the arm and rotatable relative to the arm about a second vertical axis and a horizontal axis.

In still another example, a method of operating a support apparatus is provided and includes providing the support apparatus including a support member, a body coupled to and movable along the support member, an arm coupled to and rotatable relative to the body, and a platform coupled to and rotatable relative to the arm, coupling the support member to a leg of a table, wherein the table also includes a generally horizontal surface supported by and positioned above the leg, positioning the support apparatus in a storage position, in which the platform is at least partially positioned underneath the horizontal surface of the table, and moving the support apparatus from the storage position to an operating position, in which the platform is out from underneath the horizontal surface of the table.

### BRIEF DESCRIPTION OF THE DRAWINGS

FIG. 1 is a top perspective view of an exemplary support apparatus connected to a leg of an exemplary table, the support apparatus is shown in an operating position;

FIG. 2 is a bottom perspective view of the support apparatus and the table leg shown in FIG. 1;

FIG. 3 is an exploded view of the support apparatus and the table leg shown in FIG. 1;

FIG. 4 is an exploded view of a portion of the support apparatus shown in FIG. 1;

FIG. 5 is an exploded view of a portion of the support apparatus shown in FIG. 1;

FIG. 6 is an exploded view of a portion of the support apparatus shown in FIG. 1;

FIG. 7 is a front view of the support apparatus shown in FIG. 1, the support apparatus is shown with a support platform in an angled position between horizontal and vertical;

FIG. 8 is a front view of the support apparatus shown in FIG. 1, the support apparatus is shown with the support platform in a vertical position;

FIG. 9 is a top perspective view of the support apparatus and a portion of the table shown in FIG. 1, the support apparatus is shown in a storage position;

FIG. 10 is a bottom perspective view of a portion of another exemplary support apparatus;

FIG. 11 is an exploded view of a portion of the support apparatus shown in FIG. 10;

FIG. 12 is a bottom view of a portion of the support apparatus shown in FIG. 10; and

FIG. 13 is a cross-sectional view taken along line 13-13 in FIG. 12 with the support apparatus shown in multiple positions.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

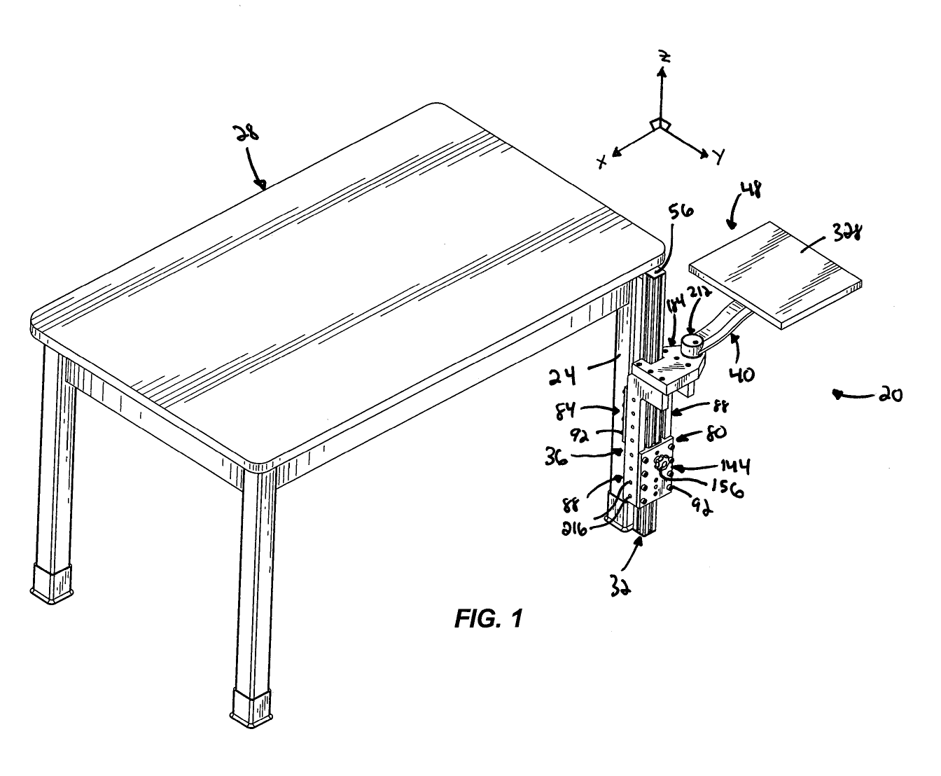

With reference to FIG. 1, an exemplary support apparatus 20 is illustrated and is connected to a leg 24 of an exemplary table 28. While the support apparatus 20 is attached to a table 28 in the illustrated exemplary embodiment, it should be understood that the support apparatus 20 may be connected to a wide variety of different tables or to a wide variety of objects or surfaces other than a table. It should also be understood that the support apparatus 20 may be connected to portions of a table 28 other than a table leg 24. It should further be understood that the illustrated exemplary support apparatus 20 is only one of a variety of different exemplary support apparatuses of the present invention and all are intended to be within the spirit and scope of the present invention.

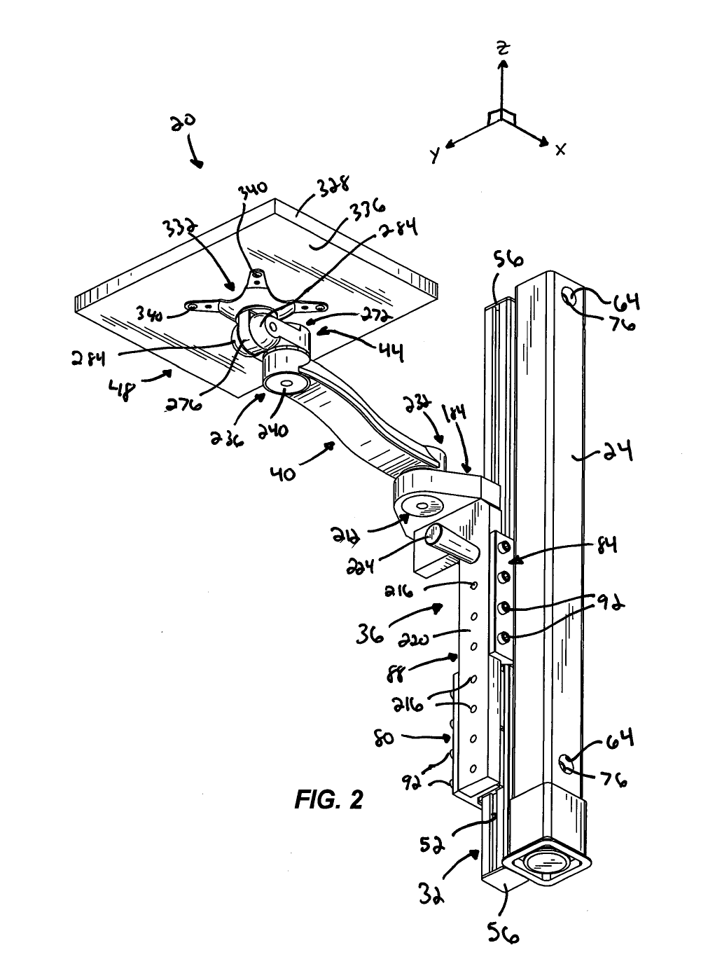

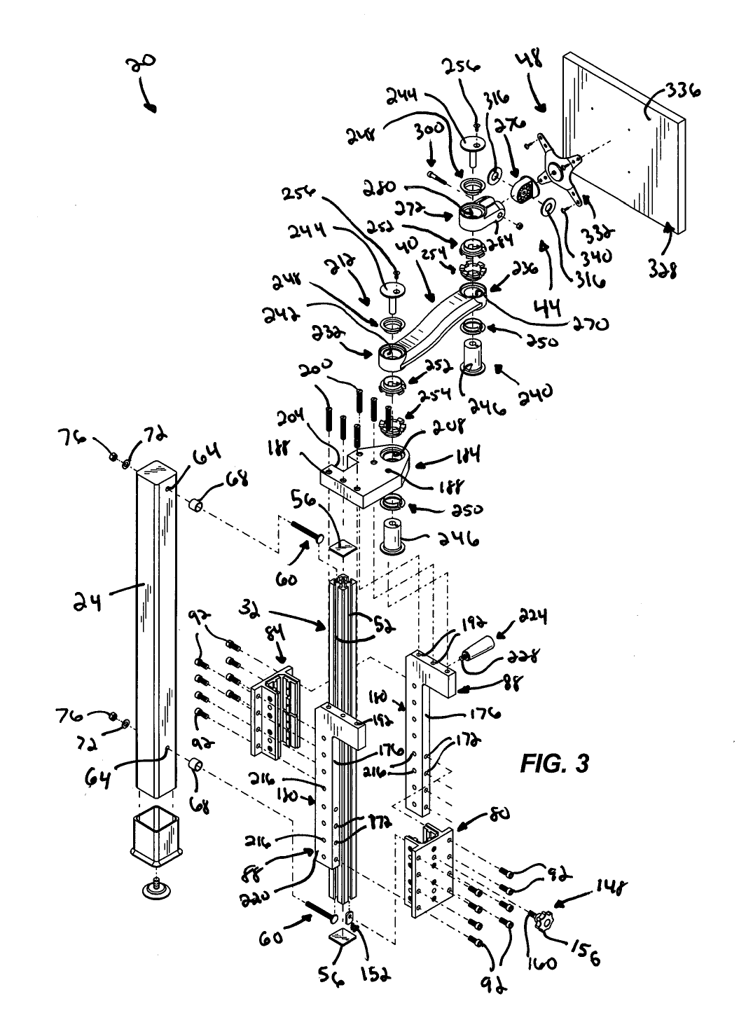

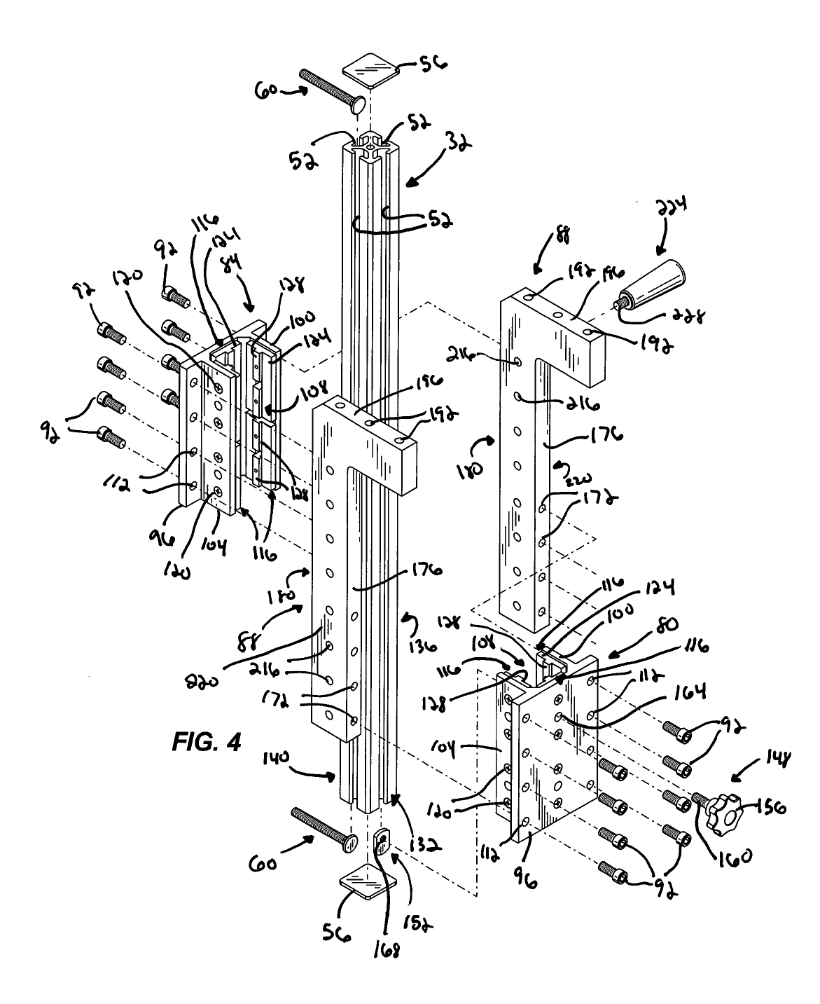

With continued reference to FIG. 1, the support apparatus 20 is capable of supporting a wide variety of objects and is adjustable between a variety of different positions in order to position a supported object as desired. With additional reference to FIGS. 2-4, the support apparatus 20 includes a support member or post 32, a body 36, an arm 40, a pivotal assembly 44, and a support platform 48. The support post 32 includes a plurality of channels 52 with one channel 52 defined in each of four sides of the support post 32. An end cap 56 is connected to each end of the support post 32 and the support post 32 may be connected to the leg 24 of a table 28. Two threaded fasteners 60 such as, for example, bolts are used to connect the support post 32 to the table leg 24. Heads of the fasteners 60 are introduced into the one of the support post channels 52 closest to the table leg 24. For example, the head of one fastener 60 may be introduced into the channel 52 from one end of the channel 52 and the head of the other fastener 60 may be introduced into the channel 52 from the other end of the channel 52. The fasteners 60 are slid along the channel 52 to appropriate heights, which may be defined by positions aligned with apertures 64 defined in the table leg 24. Upon alignment of the fasteners 60 with the apertures 64 in the table leg 24, the fasteners 60 are inserted through spacers 68, which are positioned between the support post 32 and the table leg 24, then the fasteners 60 are inserted into the apertures 64 of the table leg 24, and a washer 72 and a nut 76 are introduced onto the end of each fastener 60 and tightened to connect the support post 32 to the table leg 24.

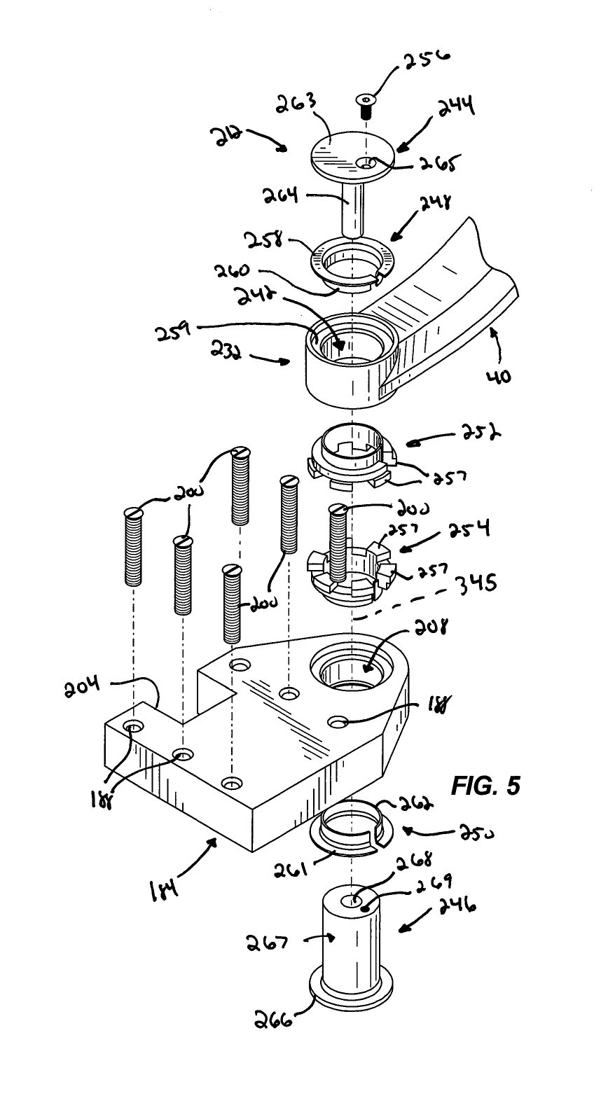

With continued reference to 1-4 and additional reference to FIG. 5, the body 36 of the support apparatus 20 is illustrated. The body 36 includes a front member 80, a rear member 84, a pair of side members 88, and a plurality of fasteners 92 for connecting the front, rear, and side members together. In the illustrated exemplary embodiment, the front and rear members 80, 84 are substantially similar in configuration. Thus, only the front member 80 will be described in detail herein.

The front member 80 includes a first portion 96, a second portion 100, and a third portion 104, with the second and third portions 100, 104 extending from the first portion 96 and being spaced apart from each other to define a cavity 108. A plurality of apertures 112 are defined in the first portion 96 externally of the locations where the second and third portions 100, 104 extend from the first portion 96. Such apertures 112 are capable of receiving a complementary number of fasteners 92. In the illustrated exemplary embodiment, eight apertures 112 are defined through the first portion 96 for receiving eight fasteners 92. Alternatively, any number of apertures 112 may be defined in the first portion 96 for receiving a corresponding number of fasteners 92. The front member 80 also includes a plurality of guide members 116 for cooperating with the support post 32 to guide the front member 80 along the support post 32. In the illustrated exemplary embodiment, the front member 80 includes six guide members 116 with two guide members 116 connected to an interior surface of the second portion 100 with fasteners 120, two guide members 116 connected to an interior surface of the third portion 104 with fasteners 120, and two guide members 116 connected to an interior surface of the first portion 96, with fasteners 120, at a location between the second and third portions 100, 104. Each guide member 116 includes a backing 124 and a pair of projections 128 extending from the backing 124 that are complementarily shaped to the channels 52 defined in the support post 32. The projections 128 are positioned in the adjacent channel 52, slide along the channel 52 as the body 36 slides along the support post 32, and inhibit lateral movement of the body 36 relative to the support post 32. For example, the projections 128 on the guide members 116 connected to the first portion 96 are positioned in the channel 52 defined in the front surface 132 of the support post 32, the projections 128 on the guide members 116 connected to the second portion 100 are positioned in the channel 52 defined in one side 136 of the support post 32, and the projections 128 on the guide members 116 connected to the third portion 104 are positioned in the channel 52 defined on an opposite side 140 of the support post 32.

One difference between the front member 80 and the rear member 84 is that the front member 80 includes an adjustable securement device 144 for adjustably securing the body 36 to the support post 32. In the illustrated exemplary embodiment, the securement device 144 includes an actuator 148 and a securement member 152. The actuator 148 includes a knob 156 and a threaded member 160 extending from the knob 156. The threaded member 160 extends through a securement aperture 164 defined through the first portion 96 of the front member 80 and in alignment with the channel 52 defined in the front surface 132 of the support post 32. The securement member 152 is positioned in the channel 52 defined in the front surface 132 of the support post 32 and includes an aperture 168 for threadably receiving the threaded member 160 of the actuator 148. The securement member 152 is wider than the opening of the channel 52, thereby inhibiting the securement member 152 from being pulled through the opening and out of the channel 52.

With continued reference to FIGS. 1-5, the side members 88 are substantially similar in configuration and have a generally inverted “L” shape. Each side member 88 includes a plurality of connection apertures 172, a portion of which are for connecting to the front member 80 and another portion of which are for connecting to the rear member 84. As illustrated, the plurality of connection apertures 172 defined in a front surface 176 of the side members 88 are located near a bottom of the side members 88 and the plurality of connection apertures 172 defined in a rear surface 180 of the side members 88 are located near a top of the side members 88. Thus, the front member 80 connects near the bottom of the side members 88 and the rear member 84 connects near the top of the side members 88. As indicated above, the projections 128 of the guide members 116, which are connected to the front and rear members 80, 84, are disposed in respective channels 52 of the support post 32. Thus, the second and third portions 100, 104 of the front and rear members 80, 84 are disposed externally of the support post 32 and between the support post 32 and the side members 88.

With additional reference to FIG. 5, the body 36 further includes a top member 184 including a plurality of connection apertures 188 aligned with a plurality of connection apertures 192 defined in top surfaces 196 of the side members 88 for receiving fasteners 200 for connecting the top member 184 with the side members 88. The top member 184 also defines a support post recess or slot 204 for receiving the support post 32 therein and further defines a bearing aperture 208 for receiving a bearing assembly 212 (described in more detail below). Additionally, the side members 88 include a plurality of handle apertures 216 defined in exterior surfaces 220 thereof for providing multiple connection locations for an adjustment handle 224. The adjustment handle 224 may connect to any of the handle apertures 216 and provides a user with an object to grasp the body 36 and slide the body 36 along the support post 32. In the illustrated exemplary embodiment, the adjustment handle 224 includes a threaded projection 228 that is threadably connectable to any of the handle apertures 216. Alternatively, the adjustment handle 224 may be coupled to the side members 88 in a variety of other manners, all of which are intended to be within the spirit and scope of the present invention.

Referring now to FIGS. 1-3, 5, and 6, the arm 40 is longitudinal and smoothly curves upward from a first end 232 to a second end 236, thereby positioning the second end 236 at an elevation above the first end 232. The first end 232 of the arm 40 is coupled to the top member 184 of the body 36 via a first bearing assembly 212 and the second end 236 of the arm 40 is coupled to a pivotal assembly 44 via a second bearing assembly 240. The first bearing assembly 212 is laterally offset from a central longitudinal axis 239 of the support post 32 (described in more detail below). The first and second bearing assemblies 212, 240 are substantially identical and, therefore, only the first bearing assembly 212 will be described herein in detail.

With particular reference to FIG. 5, the first bearing assembly 212 is disposed in a first arm bearing opening 242 defined in the first end 232 of the arm 40 and includes a male shoulder spacer 244, a female shoulder spacer 246, a first sleeve member 248, a second sleeve member 250, a first spline sleeve member 252, a second spline sleeve member 254, and a fastener 256. The first and second spline sleeve members 252, 254 each include a plurality of projections 257 that interlace with each other when the bearing assembly 212 is assembled. The first sleeve member 248 includes a flange 258 that engages a shoulder 259 defined in the first arm bearing opening 242 and an engagement portion 260 extending downward into the first arm bearing opening 242. The second sleeve member 250 includes a flange 261 that engages a shoulder (not shown) defined in the bearing aperture 208 of the top member 184 and an engagement portion 262 extending upward into the bearing aperture 208. The male shoulder spacer 244 includes a flange 263 and a projection 264 extending downward from the flange 263. A connection aperture 265 is defined through the flange 263. The female shoulder spacer 246 includes a flange 266, a projection 267 extending upward from the flange 266, a cavity 268 defined in the projection 267, and a connection aperture 269 defined in the projection 267. The projection 264 of the male shoulder spacer 244 is positioned in the cavity 268 of the female shoulder spacer 246, and the projection 267 of the female shoulder spacer 246 is positioned in central cavities of the first and second sleeve members 248, 250 and the first and second spline sleeve members 252, 254. The bearing assembly 212 is secured together by the fastener 256 threading into the connection apertures 265, 269 of the male and female shoulder spacers 244, 246.

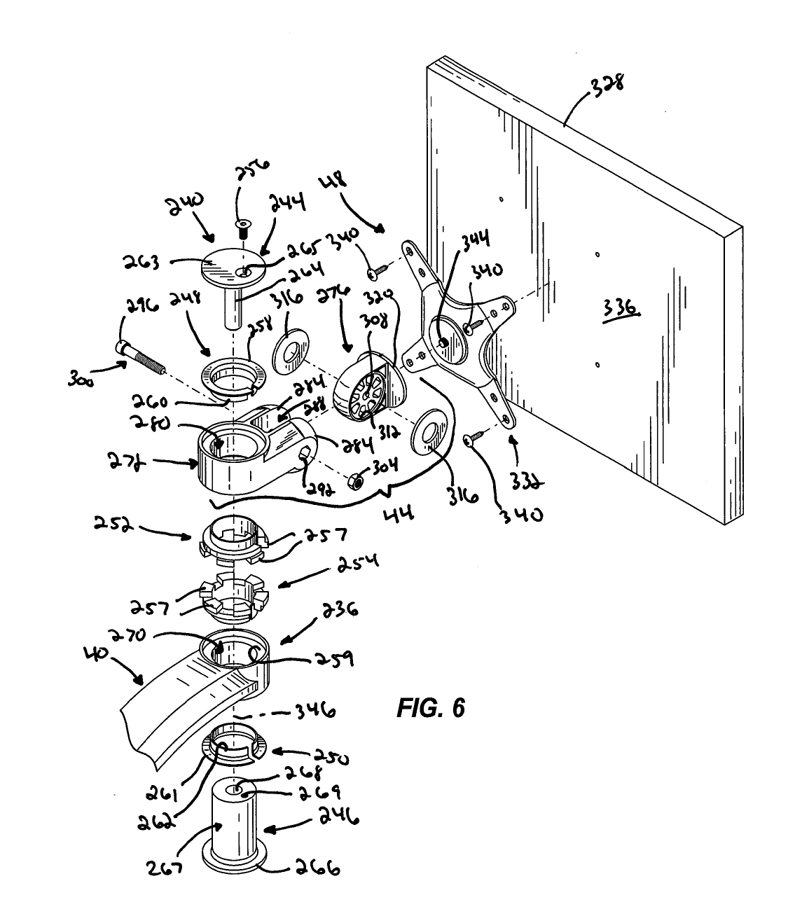

Referring now to FIG. 6, the second bearing assembly 240 is illustrated in an exploded fashion and, when assembled, is positioned in a second arm bearing opening 270 defined in the second end 236 of the arm 40.

With reference to FIGS. 2, 3, and 6, the pivotal assembly 44 includes a first pivotal member 272 and a second pivotal member 276. The first pivotal member 272 is coupled to the arm 40 via the second bearing assembly 240 and includes a bearing aperture 280 for receiving a portion of the bearing assembly 240, a pair of projections 284 spaced apart from each other to provide a cavity 288, and a connection aperture 292 defined through each of the projections 284 and in alignment with each other. One of the connection apertures 292 is generally cylindrical in shape for receiving a substantially cylindrically shaped head 296 of a pivotal shaft 300 and the other of the connection apertures 292 is hexagonal in shape to receive a hexagonal shaped nut 304 for threadably connecting to the pivotal shaft 300 to secure the shaft 300 to the pivotal assembly 44. The second pivotal member 276 is positioned in the cavity 288 defined by the first pivotal member 272 and includes a connection aperture 308 defined therethrough in alignment with the connection apertures 292 of the first pivotal member 272, all of which receive the pivotal shaft 300 to pivotally connect the first and second pivotal members 272, 276 together. The second pivotal member 276 also defines a pair of washer cavities 312, one defined in each of opposing sides of the second pivotal member 276. A washer 316 is positioned in each of the washer cavities 312 and the washers 316 are compressed between the first and second pivotal members 272, 276. In some exemplary embodiments, the washers 316 may be plastic. Alternatively, the washers 316 may be made of a variety of other materials such as, for example, metal, rubber, etc. The washers 316 are configured to provide friction between the first and second pivotal members 272, 276 ultimately providing resistance to rotation of the second pivotal member 276 relative to the first pivotal member 272. The second pivotal member 276 also includes a mounting plate 320 and a threaded aperture (not shown) defined in the mounting plate 320.

Referring now to FIGS. 1-3 and 6, the support platform 48 includes a support member 328 and a connection member 332. The connection member 332 is connected to a bottom surface 336 of the support member 328 to connect the support member 328 to the pivotal assembly 44. In the illustrated exemplary embodiment, the connection member 332 includes four legs and is connected to the bottom surface 336 of the support member 328 with four fasteners 340, one near the end of each leg of the connection member 332. Near a center of the connection member 332, the connection member 332 includes a threaded projection 344 threadably engageable with the threaded aperture defined in the second pivotal member 276 of the pivotal assembly 44.

Now that the structure of the adjustable support apparatus 20 has been described, exemplary operation of the adjustable support apparatus 20 will now be described.

The adjustable support apparatus 20 has a wide variety of adjustability. For example, a user may adjust the height of the support apparatus 20, the orientation of the arm 40 relative to the body 36, and the orientation of the support platform 48 relative to the arm 40. This adjustability provides a large variety of operating positions for the support apparatus 20 and additionally facilitates movement of the support apparatus 20 from the operating positions to a storage position.

With reference to FIGS. 1 and 2, a user may adjust the height of the support apparatus 20 by initially turning the knob 156 of the actuator 148, which unthreads the threaded member 160 from the securement member 152, to a sufficient extent that the compression force applied to an interior of the channel 52 by the securement member 152 is no longer sufficient to retain the body 36 in its current position. After the knob 156 has been sufficiently loosened, a user may grasp the handle 224 and pull or push the body 36 to the desired height. Since the body 36, arm 40, pivotal assembly 44, and support platform 48 are all coupled together, they all move vertically together. The body 36 slides vertically along the support post 32 and is guided by the projections 128 of the guide members 116 sliding within and along the channels 52 of the support post 32. Once the support apparatus 20 is adjusted to its desired height, the user turns the knob 156 in an opposite direction to that performed to loosen the knob 156, thereby threading the threaded member 160 into the securement member 152 to pull the securement member 152 toward the knob 156 and into engagement with the interior surface of the channel 52. The knob 156 is turned until the securement member 152 engages the interior surface of the channel 52 and compresses the support post 32 between the securement member 152 and the front member 80 to a sufficient extent that will retain the support apparatus 20 at the new height.

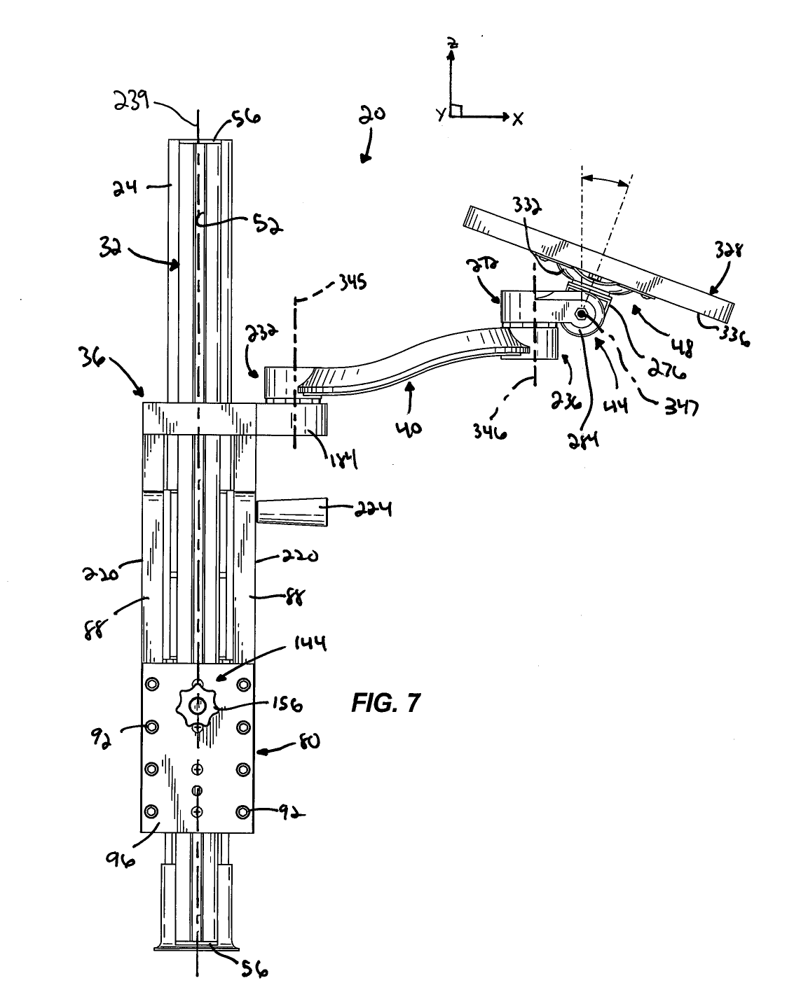

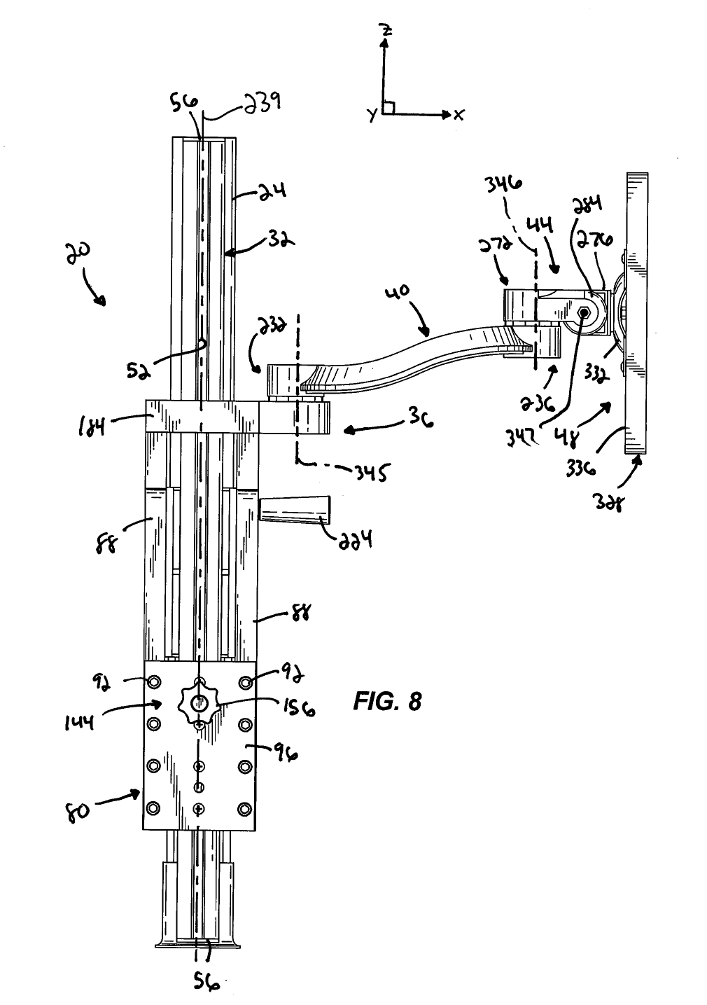

With continued reference to FIGS. 1 and 2, the first and second bearing assemblies 212, 240 allow the arm 40 to rotate relative to both the body 36 and the support platform 48. The arm 40 is rotatable relative to the body 36 through a wide range of angles about a first vertical axis 345, as shown in FIGS. 7 and 8, defined by and through a center of the first bearing assembly 212. The central longitudinal axis 239 of the support post 32 extends in a z-direction of a three-dimensional coordinate system including an x-direction, a y-direction, and the z-direction (see FIGS. 1, 2, and 7-9). The first vertical axis 345 is offset from the central longitudinal axis 239 of the support post 32 in both the x-direction and the y-direction. The first bearing assembly 212 may allow 360° of rotation about axis 345, however, rotation may be limited by engagement of the arm 40 and/or the support platform 48 with the table leg 24 and/or other portions of the table 28. Offsetting the first vertical axis 345 from the central longitudinal axis 239 in this manner allows the arm 40 to move relative to the support post 32 and table leg 24 to position the apparatus 20 in the storage position. The support platform 48 is rotatable relative to the arm 40 through a wide range of angles about a second vertical axis 346, as shown in FIGS. 7 and 8, defined by and through a center of the second bearing assembly 240. The second bearing assembly 240 may allow 360° of rotation about axis 346, however, rotation may be limited by engagement of the support platform 48 and/or the arm 40 with the table leg 24 and/or other portions of the table 28.

In the illustrated exemplary embodiment, the three-dimensional coordinate system is shown with the z-direction representing a vertical direction and the x and y-directions representing a horizontal plane perpendicular to the vertical z-direction. It should be understood that the x, y, and z-directions may extend in any orientation relative to each other and any of the x, y, and z-directions may extend in the vertical direction and the other two directions represent a plane perpendicular to the vertical direction.

With continued reference to FIGS. 1 and 2 and additional reference to FIGS. 7 and 8, the support platform 48 may also rotate about a horizontal axis 347 defined along the shaft 300 of the pivotal assembly 44. The support platform 48 may rotate between a horizontal position (see FIGS. 1 and 2) and a vertical position (see FIG. 8). In addition, the support platform 48 may rotate to and be retained in a variety of positions between horizontal and vertical. One such exemplary position is shown in FIG. 7. The friction generated by compression of the washers 316 between the first and second pivotal members 272, 276 allows the support platform 48 to be retained in positions between horizontal and vertical. The material of the washers 316 and the extent to which the washers 316 are compressed between the first and second pivotal members 272, 276 determine the amount of friction and the amount of resistance to rotation of the support platform 48 about the horizontal axis. The quantity of compression of the washers 316 may be adjusted by tightening or loosening the shaft 300 with the nut 304.

In some exemplary embodiments, the friction facilitated by the washers 316 may be sufficient to retain the support platform 48 at a position up to about ten degrees from horizontal. If the support platform 48 is rotated further than the about ten degree angle, the support platform 48 may not be retained in position. Rather, the support platform 48 may continue to rotate under the force of gravity until it comes to rest in the vertical position.

In other exemplary embodiments, the friction facilitated by the washers 316 may be sufficient to retain the support platform 48 at any position between vertical and horizontal.

In yet other exemplary embodiments, it may not be desirable to have the support platform 48 retained at any position between the horizontal and vertical positions. In such embodiments, no washers may be used or the washers 316 may not provide sufficient friction to retain the support platform 48 in any position between the horizontal and vertical positions.

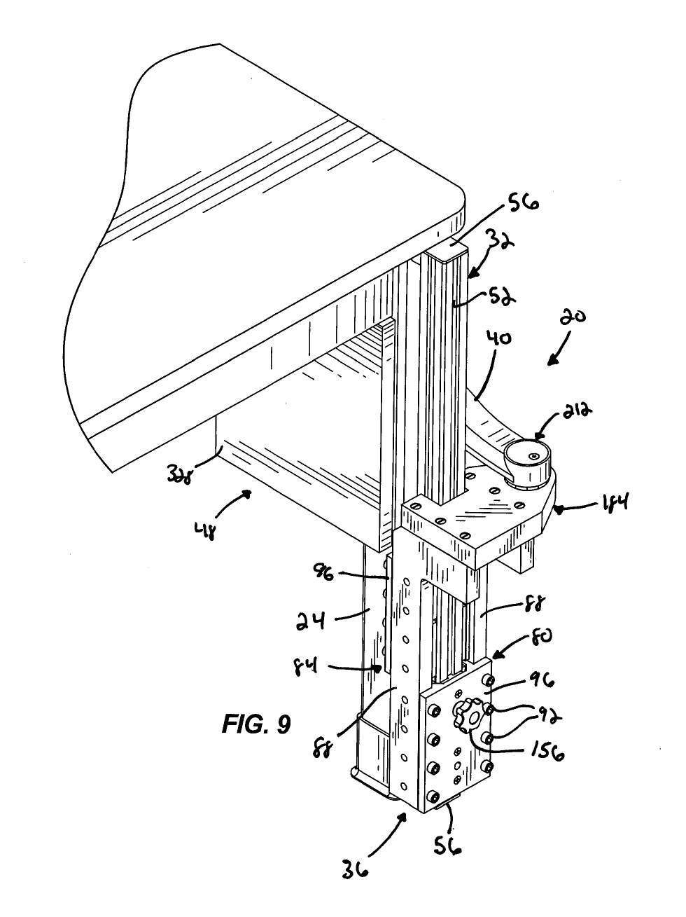

With reference to FIGS. 1, 8, and 9, the support apparatus 20 may be moved from any one of a plurality of operating positions to a storage position and vice versa. To move the support apparatus 20 from the operating position shown in FIG. 1 to a storage position shown in FIG. 9, the support member 328 is rotated from a horizontal position (see FIG. 1) to a vertical position (see FIG. 8), the support apparatus 20 is lowered to a position to enable the support member 328 to swing below the table top, and the arm 40 and the support member 328 are rotated under the table top to orient the support apparatus 20 in the storage position shown in FIG. 9. By having the first bearing assembly 212 and, as a result, the first vertical axis 345 offset from the central longitudinal axis 239 of the support post 32 in both the x-direction and the y-direction, the arm 40 is capable of rotating to a necessary position in order to orient the support apparatus 20 in the storage position without interfering with the support post 32 or the table leg 24. These steps are not necessarily required to be performed in the order introduced above. Rather, the steps may occur in a variety of different orders. For example, the height of the support apparatus 20 may be adjusted first. Also, for example, the arm 40 and support member 328 may be swung under the table top prior to rotating the support member 328 from the horizontal position to the vertical position.

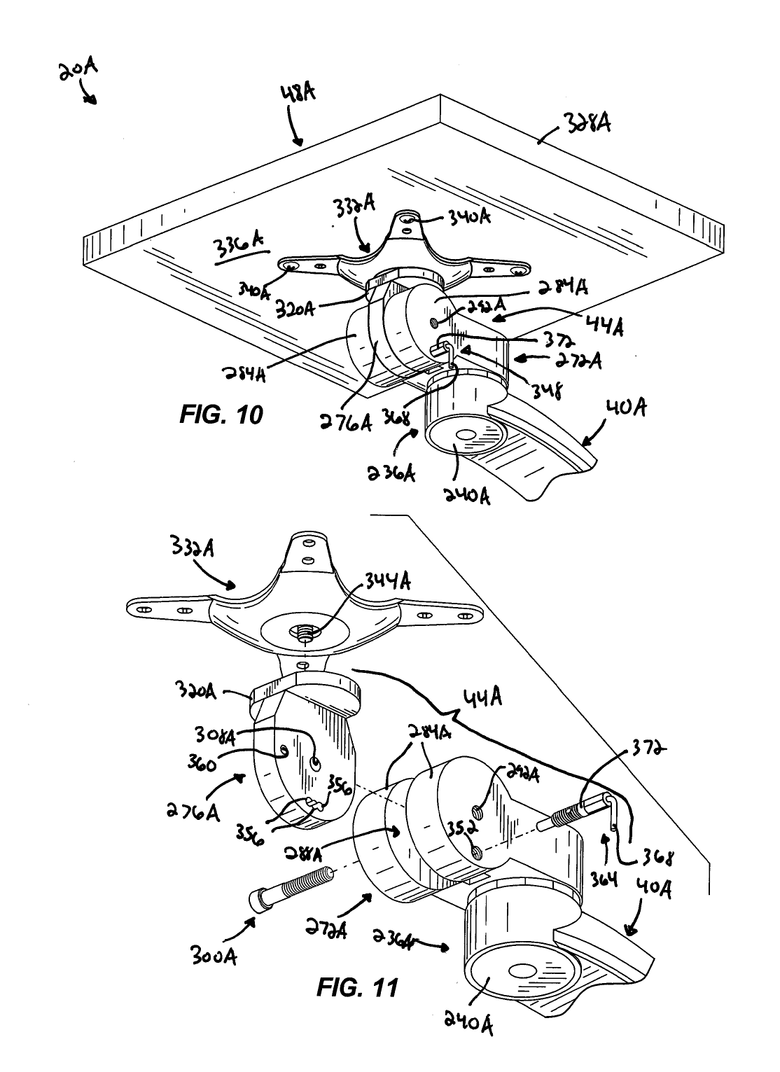

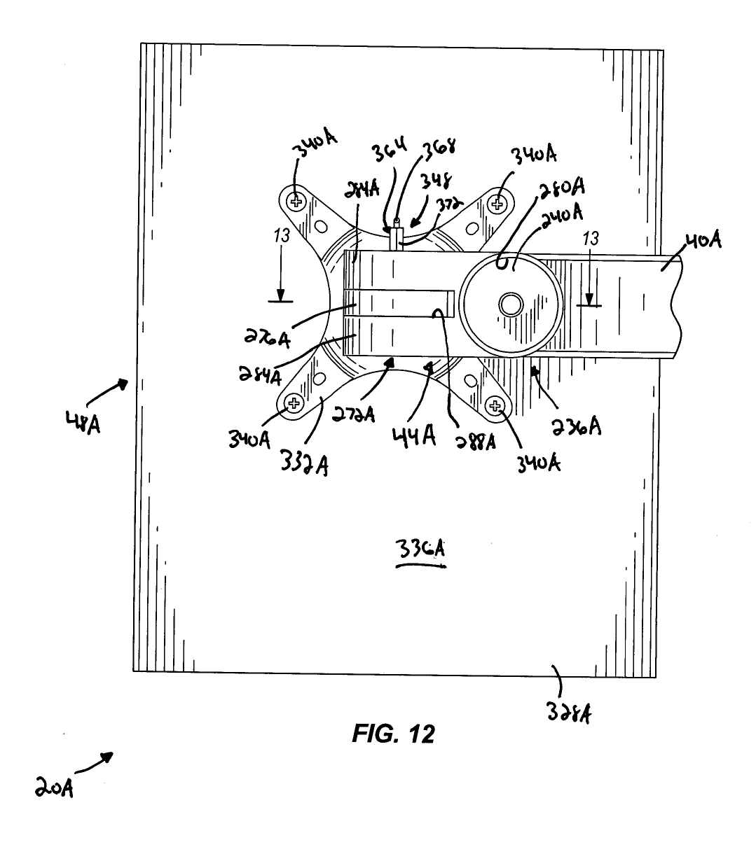

Referring now to FIGS. 10-13, another exemplary support apparatus 20A is illustrated. Common elements between the exemplary support apparatus 20A of FIGS. 10-13 and the exemplary support apparatus 20 of FIGS. 1-9 are identified by the same reference numbers and an “A”.

In this exemplary embodiment of the support apparatus 20A, the support apparatus 20A includes a locking assembly 348 coupled to the pivotal assembly 44A for positively locking the support platform 48A in place. In the illustrated exemplary embodiment, the support platform 48A may be locked in three operating positions and one storage position. Alternatively, the support platform 48A may be locked in any number of operating positions and any number of storage positions. Returning to the illustrated exemplary embodiment, the locking assembly 348 comprises an aperture 352 defined through one of the projections 284A of the first pivotal member 272A, a plurality of operating apertures 356 defined through the second pivotal member 276A, a storage aperture 360 defined in the second pivotal member 276A, and a pin assembly 364.

The pin assembly 364 includes a pin 368, a pin support 372, and a biasing member (not shown). The pin support 372 is positioned within the aperture 352 defined in the projection 284A and rigidly secured to the first pivotal member 272A. In the illustrated exemplary embodiment, the pin support 372 may be threaded into the aperture 352 defined in the first pivotal member 272A. Alternatively, the pin support 372 may be coupled to the first pivotal member 272A in other manners such as, for example, bonding, adhering, press-fit, friction-fit, or any other manner The pin 368 extends through and is moveable relative to the pin support 372. The biasing member is coupled to the pin 368 and biases the pin 368 inward toward the second pivotal member 276A. In the illustrated exemplary embodiment, the biasing member is disposed within the pin support 372. In other exemplary embodiments, the biasing member may be disposed externally of the pin support 372 or disposed in other positions relative to the pin support 372. A user may pull the pin 368 outward away from the second pivotal member 276, thereby compressing the biasing member against the pin support 372, and upon release of the pin 368, the biasing member will bias the pin 368 back toward the second pivotal member 276A. When the pin 368 is in its fully inward position, the pin 368 is sufficiently long to extend completely through the projection 284A and into the cavity 288A defined between the two projections 284A. Since the second pivotal member 276A is positioned within the cavity 288A, the orientation of the second pivotal member 276A will determine how far the pin 368 will move inward. More particularly, the second pivotal member 276A includes three operating apertures 356 defined therein and the second pivotal member 276A may be rotated relative to the first pivotal member 272A to align any one of the operating apertures 356 with the pin 368. The second pivotal member 276A may also be rotated to align the storage aperture 360 with the pin 368. When one of the operating or storage apertures is aligned with the pin 368, the biasing member will bias the end of the pin 368 into the aligned aperture.

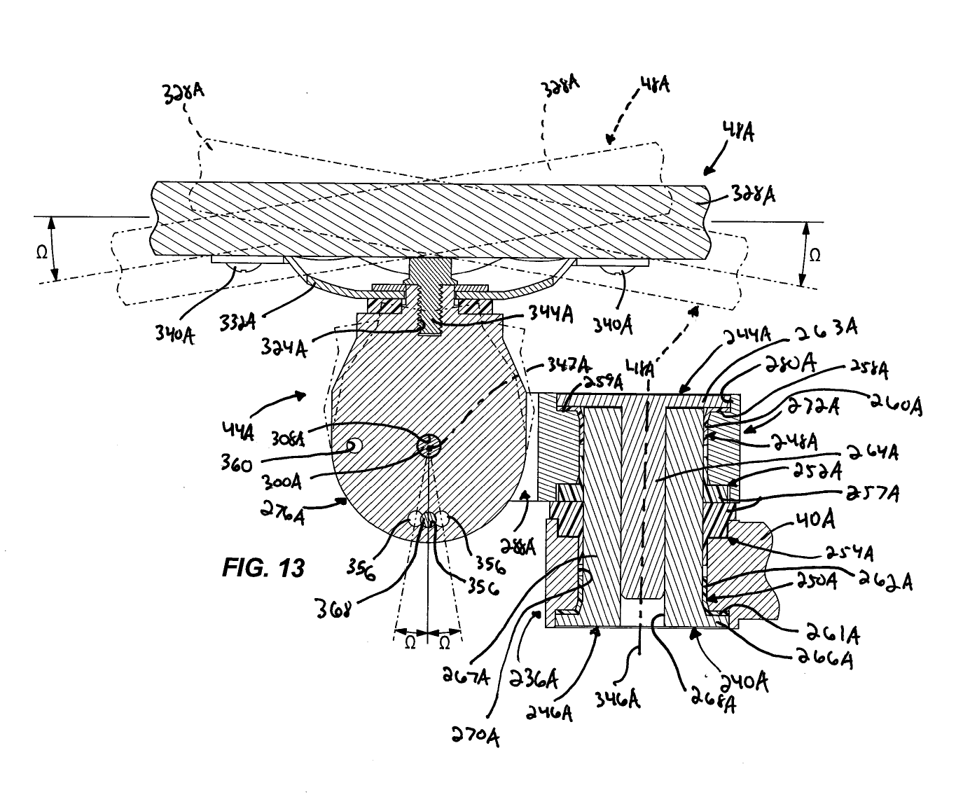

With particular reference to FIG. 13, the middle operating aperture 356 corresponds to a horizontal position of the support platform 48A. Accordingly, the support platform 48A will be in its horizontal position (shown in solid lines) when the pin 368 is in the middle operating aperture 356. As illustrated, one operating aperture 356 is disposed on each side of the middle operating aperture 356 and each of these operating apertures 356 corresponds to an angled position of the support platform 48A at an angle between horizontal and vertical. It should be understood that the angled positions of the support platform 48A may be at any angle between horizontal and vertical and that any number of operating apertures 356 may be defined in the second pivotal member 276A to provide any number of angled positions between horizontal and vertical. For example, the angles of the angled positions may be 5°, 10°, 20°, 30°, 40°, 45°, or any other angle between horizontal and vertical.

The pin 368 may also be positioned in the storage aperture 360 to position the support platform 48A in its storage position. In such an instance, the support platform 48A is positioned in its vertical position and the pin 368 is inserted into the storage aperture 360 to lock the support platform 48A in its storage position.

Exemplary operations of the support apparatus 20A will be described herein. With reference to FIG. 10, the support platform 48A is illustrated in its horizontal position. If a user desires to rotate the support platform 48A from a horizontal position to an angled position, the user grasps and pulls the pin 368 outward away from the second pivotal member 276A. Outwardly pulling the pin 368 removes the end of the pin 368 from the middle operating aperture 356 of the second pivotal member 276A. Once the pin 368 is pulled out of the middle aperture 356, the user may rotate the support platform 48A to a desired angle. Once the support platform 48A is positioned in the desired angled position, the user releases the pin 368 and the biasing member biases the end of the pin 368 into the angled operating aperture 356 aligned with the pin 368. When the pin 368 inserts into the angled operating aperture 356, the support platform 48A is secured in the angled position. The user may repeat this process as many times as desired to move the support platform 48A to other angled operating positions or back to the horizontal position. When a user desires to store the support apparatus 20A, the user needs to move the support platform 48A to its storage position, which, in the illustrated exemplary embodiment, is a vertical position. The user grasps and outwardly pulls the pin 368 away from the second pivotal member 276A, thereby removing the end of the pin 368 from the operating aperture 356. Once the pin 368 is pulled out of the operating aperture 356, the user may rotate the support platform 48A to the vertical position. Once the support platform 48A is positioned in the vertical position, the storage aperture 360 aligns with the pin 368 and the user releases the pin 368, which inserts into the storage aperture 360 under the bias of the biasing member. When the pin 368 inserts into the storage aperture 360, the support platform 48A is secured in the vertical or storage position.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A support apparatus comprising:
a support member including a longitudinal central axis extending in a z-direction of a three-dimensional coordinate system including an x-direction, a y-direction, and the z-direction;
a body coupled to and movable along the support member;
an arm coupled to the body and rotatable relative to the body about a first vertical axis, wherein the first vertical axis is offset from the longitudinal central axis of the support member in both the x-direction and the y-direction; and
a platform coupled to the arm and rotatable relative to the arm about a second vertical axis and a horizontal axis.

2. The support apparatus of claim 1, wherein the first vertical axis and the second vertical axis generally extend in the z-direction and the horizontal axis extends in a plane defined by the x-direction and the y-direction of the three-dimensional coordinate system.

3. The support apparatus of claim 1, wherein the support member includes a front surface, a rear surface opposite the front surface, a right surface, and a left surface opposite the right surface, and wherein the first vertical axis is positioned in front of the front surface and to one of a right of the right surface or a left of the left surface.

4. The support apparatus of claim 1, wherein the support apparatus is movable between a plurality of positions, and wherein the first vertical axis remains stationary relative to the support member as the support apparatus moves between the plurality of positions and the second vertical axis moves relative to the support member as the support apparatus moves between the plurality of positions.

5. The support apparatus of claim 1, wherein the body includes a member positioned in front of the support member and to a side of the support member, the member defining a recess therein for receiving at least a portion of the support member, the support apparatus further comprising a bearing supported by the member of the body in front of and to a side of the support member, and wherein the bearing defines the first vertical axis.

6. The support apparatus of claim 1, further comprising a pivotal assembly coupled between the arm and the platform, wherein the platform is movable to an operating position and the pivotal assembly is adapted to retain the platform in the operating position.

7. The support apparatus of claim 6, wherein the pivotal assembly includes a washer adapted to be compressed to provide sufficient friction to retain the platform in the operating position.

8. The support apparatus of claim 1, further comprising a locking assembly coupled to the platform, wherein the platform is movable to an operating position and the locking assembly is adapted to lock the platform in the operating position.

9. A method of operating a support apparatus, the method comprising:
providing the support apparatus including a support member, a body coupled to and movable along the support member, an arm coupled to and rotatable relative to the body, and a platform coupled to and rotatable relative to the arm;
coupling the support member to a leg of a table, wherein the table also includes a generally horizontal surface supported by and positioned above the leg;
positioning the support apparatus in a storage position, in which the platform is at least partially positioned underneath the horizontal surface of the table; and
moving the support apparatus from the storage position to an operating position, in which the platform is out from underneath the horizontal surface of the table.

10. The method of claim 9, wherein the platform is completely underneath the horizontal surface of the table with the support apparatus in the storage position.

11. The method of claim 9, wherein the leg of the table includes a front surface and a rear surface opposite the front surface, and wherein the support member is coupled to the front surface of the leg and the platform at least partially extends behind the rear surface of the leg when the support apparatus is in the storage position.

12. The method of claim 11, wherein the leg of the table also includes a right surface and a left surface opposite the right surface, and wherein the arm extends along and generally parallel to one of the right surface and the left surface of the leg when the support apparatus is in the storage position.

13. The method of claim 9, wherein the support member includes a longitudinal central axis extending in a z-direction of a three-dimensional coordinate system including an x-direction, a y-direction, and the z-direction, and wherein the arm is rotatable relative to the body about a first vertical axis that is offset from the longitudinal central axis of the support member in both the x-direction and the y-direction.
